(19) United States
(12) Patent Application Publication
(10) Pub. No.: US 2004/0026674 A1
(43) Pub. Date: Feb. 12, 2004

(54) Utility bar with bowed shank

(76) Inventors: Hector Hernandez, Fullerton, CA (US); Jaime Nash, Rancho Santa Margarita, CA (US)

Correspondence Address: CONNORS ASSOCIATES, 1600 DOVE ST, SUITE 220, NEWPORT BEACH, CA, 92660

(21) Appl. No.: 10/615,097

(22) Filed: Jul. 8, 2003

Related U.S. Application Data
(63) Continuation of application No. 10/216,140, filed on Aug. 9, 2002, now Pat. No. 6,598,857.

(51) Int. Cl. B66F 15/00

(52) U.S. Cl. 254/25

(57) ABSTRACT

A utility bar is disclosed comprising a bowed shank, a lever piece and a junction that couples the shank to the lever piece. A chisel may also be coupled to the bowed shank.

### RELATED PATENT APPLICATIONS & INCORPORATION BY REFERENCE

This application is a continuation application of U.S. Ser. No. 10/216,140, entitled “Utility Bar With Bowed Shank,” filed Aug. 9, 2002, now U.S. Pat. No. ______. This related application is incorporated herein by reference and made a part of this application. Moreover, the inventors incorporate herein by reference any and all U.S. patents, U.S. patent applications, and other documents cited or referred to in this related application or cited or referred to in the U.S. patents and U.S. patent applications incorporated herein by reference.

### BACKGROUND OF INVENTION

Numerous utility bars or prying tools have been known, these exhibiting different configurations and sizes. Most of the bars operate as a lever. A first class lever is one wherein the load to be overcome is at or near one end of a rod, and a force is applied at or near the other end of the rod, and a pivot point (fulcrum) is somewhere along the rod in between the applied force and load. Thus, the user seeks to obtain a mechanical advantage by placing one end of the rod adjacent to the object to be moved, and providing a pivot point about which a longer moment arm is provided so that substantial forces can be applied to the object to be pried open or moved. Examples of utility bars are disclosed in U.S. Pat. No. 5,957,429 and U.S. Pat. No. 6,257,553.

### SUMMARY OF INVENTION

This invention, with its several desirable features, is summarized in the CLAIMS that follow. After reading the following section entitled “DETAILED DESCRIPTION,” one will understand how the features of this invention provide its benefits, which include, but are not limited to providing a utility bar with a bowed shank that an offers improved mechanical advantage and affords the user a free end spaced from a surface of an object being levered.

The utility bar of this invention comprises a lever piece and a bowed shank integrally formed from a single piece of metal. The lever piece and a bowed shank form a substantially L-shaped prying hook, The bowed shank has a curved, longitudinally extending center line, with a first end and a second end between which the curved centerline extends. The lever piece and centerline of the shank form an angle of 90° or less.

The lever piece faces inward from the first end, and has a substantially flat and straight exterior surface. The lever piece and a bowed shank are joined together by a junction having a curved outer surface that merges with the exterior surface of the lever piece. The junction is substantially V-shaped with two legs of the junction forming an angle of 90° or greater. An interfaces between the junction and the lever piece define a start position of a traveling pivot point lying inward of the centerline. The greater the distance this start position is from the centerline, the greater the mechanical advantage provided. The bar may also include a chisel piece at the second end of the bowed shank. The chisel piece may face either outward or inwards.

### DESCRIPTION OF DRAWINGS

Some preferred embodiments of this invention, illustrating all its features, will now be discussed in detail. These embodiments depict the novel and non-obvious utility bar of this invention as shown in the accompanying drawings, which are for illustrative purposes only. These drawings includes the following figures (FIGS.), with like numerals indicating like parts:

FIG. 1 is a perspective view of the bar of this invention.

FIG. 2 is a side view of the bar.

FIG. 3 is a cross-sectional view of the bar taken along line 3-3 of FIG. 2.

FIG. 4 is view of the bar taken along ling 4-4 of FIG. 2.

FIG. 5 illustrates a circular curvature of the centerline of the shank.

FIG. 6 illustrates an elliptical curvature of the centerline of the shank.

FIG. 7 illustrates the bar inserted underneath an object.

FIG. 8 is an enlarged fragmentary view of the bar taken along line 8 of FIG. 7.

### DETAILED DESCRIPTION

### Some Preferred Embodiments

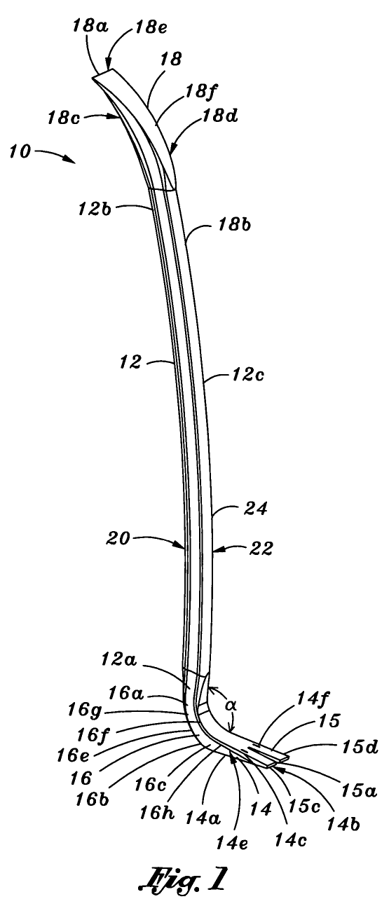

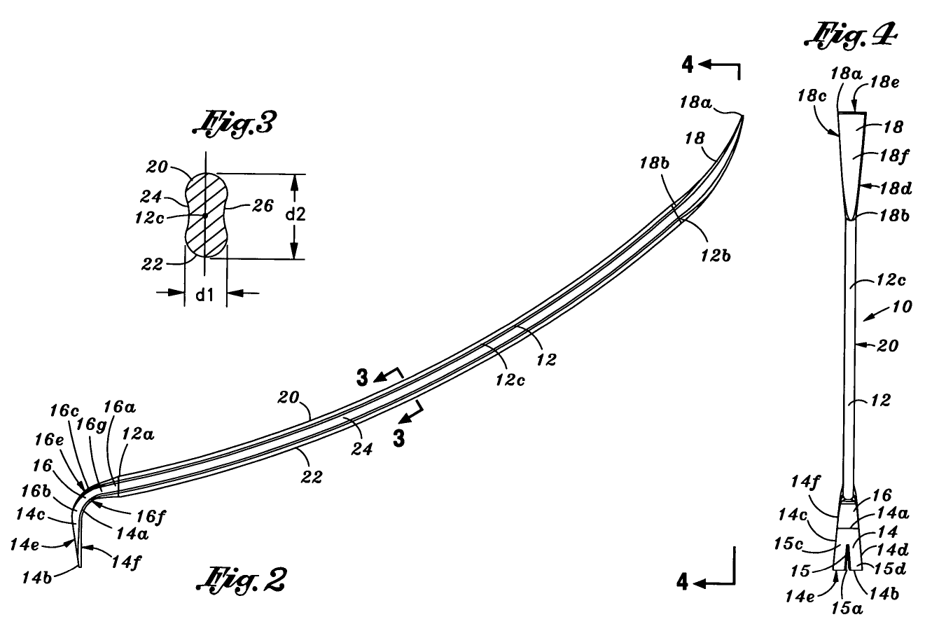

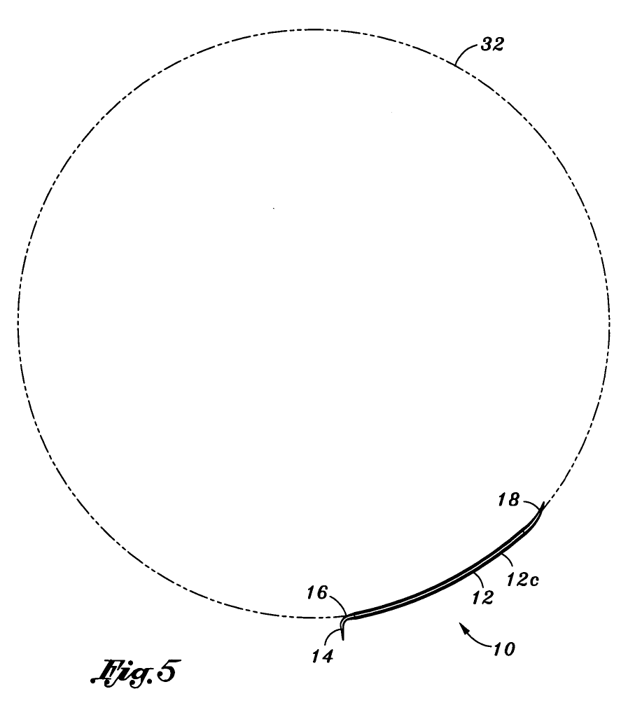

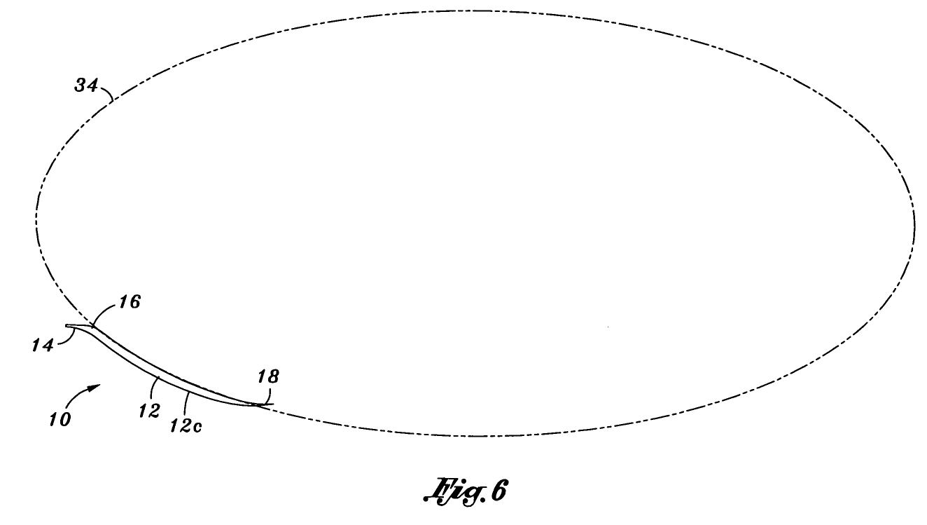

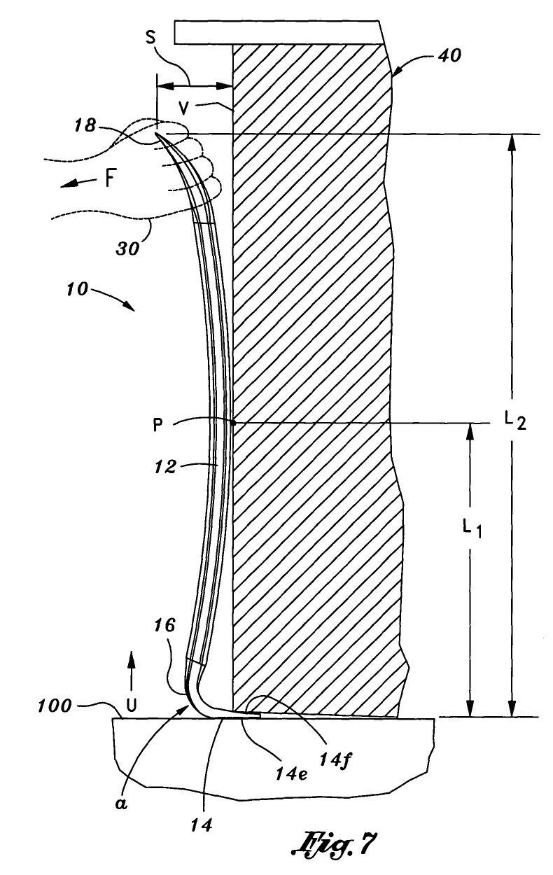

Referring to FIGS. 1, 2, 3, 4 and 8, the utility bar 10 generally comprises a bowed shank 12, a lever piece 14 and a junction 16 that couples the shank 12 and the lever 14. The shank 12 has a first end 12a and a second end 12b and a curved centerline 12c extending longitudinally between the first end 12a and second end 12b. Referring to FIG. 3, the cross-section of the shank 12 has substantially an hourglass configuration. The hourglass configuration has an outer rounded surface 20, an inner rounded surface 22, and curved surfaces 24 and 26 connecting the rounded surfaces 20, 22. The cross-section of the shank 12 may have other shapes, such as, hexagonal, elliptical, and circular. As illustrated in FIG. 5, the centerline 12c of the shank 12 may take the shape of a portion of a circle 32, or as illustrated in FIG. 6, may take the shape of a portion of an ellipse 34.

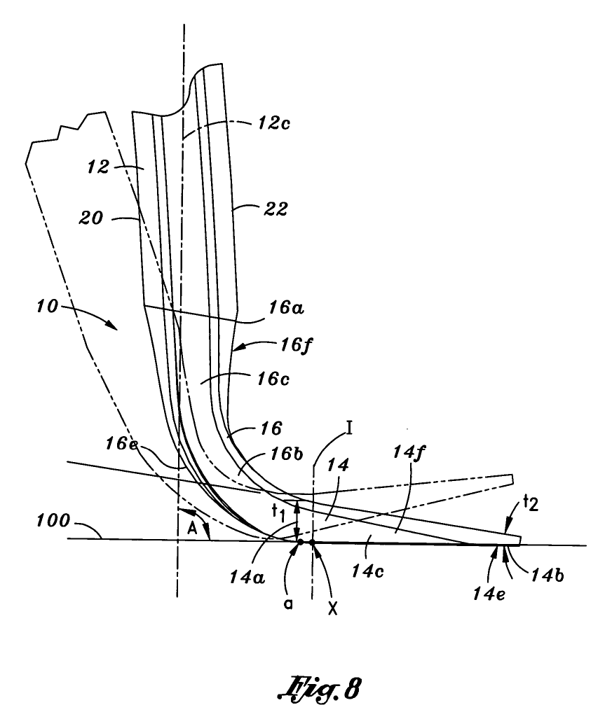

Referring to FIGS. 1, 2 and 4, the lever piece 14 is substantially a wedge in shape with a flat, straight, outer exterior surface 14e, a flat, straight, inner surface 14f, a junction end 14a, a bladed end 14b and sides 14c and 14d. The angle A between outer surface 14e of the lever piece 14 and the centerline 12c of the shank is typically ninety (90) degrees or less. In one aspect of the invention, sides 14c, 14d of the lever piece 14 are tapered, preferably wider at the bladed end 14b than at the junction end 14a. In one embodiment, the lever piece 14 has a notch 15, with the open end 15a of the notch at the bladed end 14b of the lever piece 14 that divides the lever piece 14 into two blade segments 15c and 15d. Referring to FIG. 8, the thickness t₂ of the bladed end 14b of the lever piece is less than the thickness t₁ at the junction end 14a to facilitate the insertion of the bar 10 underneath an object 40 (FIG. 7) to be lifted.

As best shown in FIGS. 1, 2 and 8, the junction 16 is a curved member having outer curved surface 16e, an inner curved surface 16f, a shank end 16a, a lever end 16b, a pair of sides 16c and 16d and a pair of legs 16g, 16h. The shank end 16a of the junction 16 is integrally coupled to the first end 12a of the shank 12 and the lever end 16b of the junction 16 is integrally coupled to the junction end 14a of the lever 14. The legs 16g and 16h of junction 16 form a substantially V-shape, and these legs 16g and 16h form an angle a of ninety degrees or greater.

The bar 10 may also comprise a curved, tapered chisel piece 18. The chisel piece 18 generally has the shape of a wedge with an inner end 18b, an outer end 18a, an inner surface 18f, an outer surface 18e, and sides 18c and 18d. The inner end 18b of the chisel piece is coupled to the second end 12b of the shank 12. The chisel piece 18 is tapered such that the inner end 18b is thicker than the outer end 18a. The chisel piece 18 typically curves in an outward direction. The chisel piece 18 may also curve inwardly.

Referring to FIGS. 7 and 8, the bar 10 is used by inserting the lever piece 14 underneath and the object 40 to be lifted such that the outer surface 14e of the lever piece faces a supporting surface 100 and the inner surface 14f faces the object 40. An intermediate portion P of the shank 12 typically contacts a vertical surface V of the object 40 at a distance 1₁ from the supporting surface 40. A user 30 lifts the object 40 by applying a force F to the chisel piece 18 attached to the shank 12. In this example, the force F is directed away from the object and is substantially perpendicular to the centerline of the shank. The shank 12 acts as one moment arm and the lever piece 14 acts as the other moment arm. The bar 10 rotates when the force F is applied, causing the object 40 to rise in direction u. The bar 10 initially rotates about a starting pivot point x located on the outer surface 16e at the intersection with the interface I. The operative moment arm of the bar 10 is the distance 1₂ between the force F and pivot point x.

Referring to FIG. 8, when force F is first applied, the pivot point is at x, which lies inward of the centerline 12c of the shank 12 and usually is at an interface I where the lever end 16b of the junction 16 and the terminus T of flat end 14a of the lever 14 meet. As shown in dotted lines in FIG. 8, with the counterclockwise rotation of the bar 10, the pivot point x moves along the outer surface 16e of the junction 16 towards the shank 12 to a point a.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A utility bar having
a substantially L-shaped configuration formed by a lever piece having a substantially flat and straight exterior surface and a bowed shank having a longitudinal curved center line,
said lever piece and bowed shank joined by a junction member including a curved outer surface extending between the lever piece and shank,
said curved outer surface of the junction member merging with the flat and straight exterior surface of the lever piece to form an interface that defines a start position of a traveling pivot point that is inward of the center line,
said flat and straight exterior surface of the lever piece being at an angle of 90° or less with respect to the center line.

2. The utility bar according to claim 1 where said centerline is configured in the shape of a portion of the circumference of a circle.

3. The utility bar according to claim 1 where said shank has a substantially hourglass cross-sectional configuration.

4. A utility bar comprising
a lever piece and a bowed shank integrally formed from a single piece of metal and defining a substantially L-shaped prying hook,
said bowed shank having a curved, longitudinally extending center line and a substantially hourglass cross-sectional configuration,
said lever piece being at an angle of 90°0 or less with respect to the center line.

5. The utility bar according to claim 4 where the center line is substantially configured in the shape of a portion of the circumference of a circle.

6. The utility bar according to claim 4 where the lever piece and bowed shank are joined together by junction member including a curved outer surface merging with a flat and straight exterior surface of the lever piece to form an interface that defines a start position of a traveling pivot point that is inward of the center line.

9. The utility bar according to claim 9 where the exterior surface of the lever piece is at an angle of 90° or less with respect to the center line.

10. A utility bar comprising
a lever piece and a bowed shank integrally formed from a single piece of metal and defining a substantially L-shaped prying hook,
said lever piece having a substantially flat and straight exterior surface,
said bowed shank having a substantially hourglass cross-sectional configuration and a curved, longitudinally extending center line that is configured in the shape of a portion of the circumference of a circle, and
said lever piece and bowed shank being joined together by junction member including a curved outer surface merging with the flat and straight exterior surface of the lever piece to form an interface that defines a start position of a traveling pivot point that is inward of the center line.
said flat and straight exterior surface of the lever piece being at an angle of 90° or less with respect to the center line.
